(19) United States
(12) Patent Application Publication
(10) Pub. No.: US 2010/0219774 A1
(43) Pub. Date: Sep. 2, 2010

(54) METHOD FOR DIMMING LIGHT SOURCES, RELATED DEVICE AND COMPUTER PROGRAM PRODUCT

(75) Inventors: Francesco Bianco, Spinea (Venezia) (IT); Alessandro Bizzotto, Castelfranco Veneto (Treviso) (IT); Alessandro Scordino, Dolo (Venezia) (IT); Nicola Zanforlin, Campodarsego (IT)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/712,217

(22) Filed: Feb. 25, 2010

(30) Foreign Application Priority Data
Feb. 27, 2009 (IT) TO2009A000145

(51) Int. Cl. H05B 39/04

(52) U.S. Cl. 315/309

(57) ABSTRACT

A method of compensating the degradation of the luminous intensity due to aging in a light source by controlling a power supply signal of said light source. The method may include: detecting the temperature of said light source; determining a parameter representative of the aging of said light source as a function of said temperature; and varying said power supply signal as a function of said parameter representative of the aging of the light source.

### CROSS-REFERENCE TO RELATED APPLICATION

This application claims priority to Italian Patent Application Serial No. TO2009A000145, which was filed Feb. 27, 2009, and is incorporated herein by reference in its entirety.

### TECHNICAL FIELD

The description refers to the techniques for optimizing lighting devices, in particular street lighting.

The description has been prepared to focus attention on its potential use in optimizing the light-emitting efficiency of a lighting device with at least one LED module.

### BACKGROUND

During the service life of an LED module, the luminous efficacy of the LED module may decrease, consequently reducing the intensity of the light emitted.

For example, by replacing one of the modules in a system comprising a plurality of LED modules, the “new” module may have a higher efficiency and therefore be more luminous than the “old” modules, resulting in uneven light emissions. This effect is manifested particularly clearly in street lighting applications, which require high levels of light intensity and usually use a plurality of LED modules connected in parallel, replacing only the defective LED modules.

Various commercial products currently available on the market make it possible to control light intensity using optical feedback. In particular, the intensity of the light emitted by the source is measured, in order to guarantee a constant value for the entire service life of the module.

The document WO 2007/019663 describes a lighting system that makes it possible to improve the performance of control with optical feedback.

### SUMMARY

A method of compensating the degradation of the luminous intensity due to aging in a light source by controlling a power supply signal of said light source. The method may include: detecting the temperature of said light source; determining a parameter representative of the aging of said light source as a function of said temperature; and varying said power supply signal as a function of said parameter representative of the aging of the light source.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. The various embodiments are described below, purely by way of a non-limiting example, with reference to the attached figures, in which:

FIG. 1 is a block diagram of a driver circuit for LED light sources; and

FIG. 2 is a flow diagram showing a possible control method for the circuit in FIG. 1.

### DESCRIPTION

The description below illustrates various specific details to provide a more comprehensive understanding of the embodiments. The embodiments may be realized without one or more of the specific details, or with other methods, components, materials, etc. In other cases, known structures, materials or operations are not shown or described in detail so as not to obscure the different aspects of the embodiments.

Reference to “an embodiment” in this description indicates that a particular configuration, structure or characteristic described in relation to the embodiment is included in at least one embodiment. Therefore, phrases such as “in one embodiment”, which may appear in various places in this description, do not necessarily refer to the same embodiment. Furthermore, specific formations, structures or characteristics may be appropriately combined in one or more embodiments.

The references used herein are used solely for convenience and therefore do not define the extent of protection or scope of the embodiments.

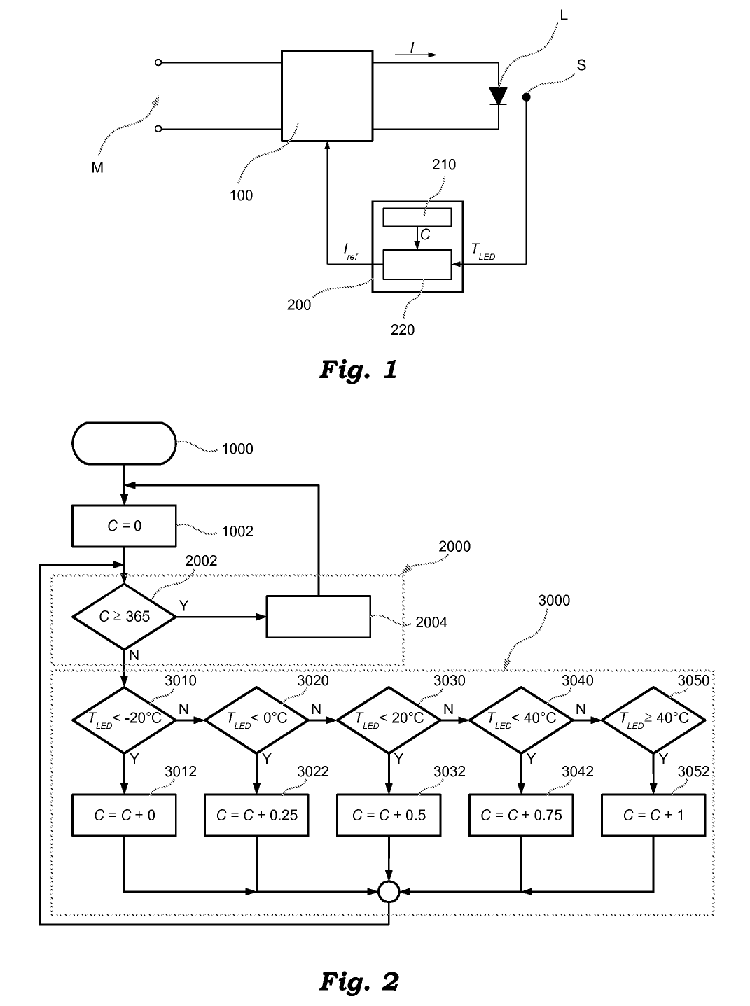

The block diagrams in FIG. 1 show a driver circuit for a light source, such as an LED light source.

In the block diagram in FIG. 1, the reference 100 indicates a conversion module. Starting from an input represented by a power supply line M (typically mains voltage) the module 100 produces a continuous current I to be fed to the LED module L (comprising one or more LEDs).

In the embodiment illustrated here, there is at least one temperature sensor S placed near to the LED module such as to measure a temperature value T_{LED} indicative of the temperature of the LED module.

This value T_{LED} is supplied to a control module 200 that controls the operation of the converter 100. The module 200 may be implemented analogically and/or digitally, for example using a microprocessor.

In one embodiment, the module 200 generates a reference signal I _{ref} to guarantee that the converter 100 feeds the LED module in order to keep the light intensity actually generated by the LED substantially stable during the entire service life of the module. The power supply signal of the LED module may therefore vary, for example on account of an increment.

The aforementioned action may be performed by manipulating the intensity of the power supply current of the LED module.

The person skilled in the art will also appreciate that, as the luminosity of a source of the type considered here is a function of the average intensity of the current passing through it, the effect of degradation may be compensated in another manner: for example manipulating the power supply voltage and/or changing the pulse width of a pulse power supply signal in accordance with the normal PWM methods used to control the luminosity of light sources (known as “dimming”).

The inventors have noted that the luminosity of a light source such as an LED module tends to diminish as a function of operating time and operating temperature. The luminous intensity of the LED module can therefore be kept stable over time by increasing the intensity of the power supply current I.

In one embodiment, the module 200 detects both the temperature, and the operating time (cumulative) of the LED module, to determine the ageing of the LED module and calculate, in a (sub) module 220 the value of a new reference signal I_{ref}used to enable luminosity to be kept constant.

In one embodiment, the module 200 calculates a new reference signal I_{ref} recursively, measuring the temperature T_{LED} of the LED module at certain time intervals and incrementing the reference signal I_{ref} as a function of the temperature T_{LED}.

For reference purposes (and without thereby being understood to limit the scope of the invention), the inventors have noted that an ordinary LED module, after one year's operation in extreme conditions, for example at the maximum operating temperature, reveals an appreciable variation in luminosity. The luminous intensity remains however substantially unchanged for a similar period of operation in optimal conditions, for example at low temperatures.

One embodiment therefore provides for the use of an ageing counter 210 to track the ageing of the LED module. One embodiment provides for the counter 210 to be incremented as a function of the operating temperature T_{LED} of the LED module, for which a given period of time has a different “weight” in terms of ageing depending on the operating conditions (for example according to the operating temperature).

In one embodiment, the operation of the counter is adjusted using the following criteria.

At least one optimum or best operating condition (at a low operating temperature) and one worst operating condition (at a high operating temperature) are determined.

Subsequently, the operating temperature T_{LED} of the light source is measured and one of the operating conditions is selected. The operating condition may be selected on the basis of a comparison with at least one reference temperature, for example selecting the operating condition that corresponds to the temperature closest to the current operating temperature.

The counter 210 is therefore manipulated to take into account the ageing of the LED module.

In one embodiment, the counter is incremented with an ageing value selected on the basis of the operating condition chosen. For example, the ageing value is greater for the worst condition and lesser for the best condition.

The person skilled in the art will also appreciate that an entirely analogous function may be performed by decrementing the counter instead of incrementing it.

In any case, starting with the new value C of the ageing counter 210, it is possible to update the reference value I_{Ref} in the module 220.

It will also be seen that, both in the case of the ageing value of the counter 210, and in the case of the reference value I_{Ref} updating need not necessarily result in the value changing. As mentioned before, the inventors have noted that in many phases a correction of the reference value may be required only after one year's actual operation.

In one embodiment, to perform the update function, i.e. to determine the updated reference value I_{Ref} on the basis of the value C of the ageing counter 210, a calculation function implemented in the module 220 is used. In one embodiment, a look-up table (LUT) is used to perform the update function.

In one embodiment, the reference value I_{Ref} is incremented if the ageing counter 210 reaches (or exceeds or drops below) a certain predefined threshold. For example, the reference value I_{Ref} may be incremented by a certain percentage every time the counter exceeds the threshold, subsequently triggering a new “ageing cycle”.

In one embodiment, the resolution of the compensation action is adjusted by changing the threshold of the counter and/or the percentage of the increment of the reference value I_{ref}.

In one embodiment, to determine the ageing or the operating condition of an LED module, an average temperature value and not an instant value is used.

For example, the average temperature of the LED module over an entire day, determined on the basis of values taken hourly, may be used. This makes it possible to implement a counter that takes into account the daily ageing of the LED module by weighting ageing as a function of the average daily operating temperature.

FIG. 2 is a flow diagram of a method for calculating the ageing of the LED module on the basis of the operating temperature over an entire day and therefore for determining the reference value I_{ref}.

Following a trigger step 1000, the ageing counter 210 is reset to 0 in a step 1002 (i.e. C=0).

Subsequently, in a phase indicated as a whole as 2000, an updated reference value I_{ref} is determined (assuming that, during the device manufacturing phase, an initial reference value is memorized in the module 220).

In the embodiment considered here, the phase 2000 involves a verification step 2002, in which it is determined whether the ageing of the LED module requires a correction of the reference value I_{ref}.

For example, the step 2002 may be realized as a comparison step between the value C of the counter and a threshold (for example, one year's actual operation or C≧365).

If no correction is required, the process continues with a phase 3000 where the ageing of the LED module is determined on the basis of the operating temperature T_{LED} measured by the sensor S.

In the embodiment considered here, the phase 3000 involves checking a series of conditions, including for example five possible operating conditions at different temperatures.

In particular, in a step 3010 the temperature of the LED module, T_{LED}, is checked to determine whether it is below −20° C. (i.e. T_{LED}<−20° C.).

If the result is positive (Y), the process continues with step 3012, representing the best condition, where the counting value of the counter is kept unchanged (for example C=C+0).

If the result is negative (N), the process continues with a step 3020, where the temperature T_{LED} is checked to determine whether it is below 0° C. (i.e. T_{LED}<0° C.).

If the result is positive (Y), the process continues with step 3022, where the counting value of the counter is incremented, for example, by a value corresponding to ¼ of one day's actual operation (C=C+0.25).

If the result is negative (N), the process continues with a step 3030.

In the flow diagram in FIG. 2, the steps 3030 and 3040 represent steps intended to identify operating conditions in which the temperature T_{LED} is between 0° C. and 20° C. (for example T_{LED}<20° C.) or between 20° C. and 40° C. (for example T_{LED}<40° C.).

For example, if the temperature T_{LED} is between 0° C. and 20° C., the counter is incremented in a step 3032 by a value corresponding to one half day's actual operation (for example C=C+0.5). If the temperature T_{LED} is between 20° C. and 40° C., the counter is incremented in a step 3042 by a value corresponding to ¾ of one day's actual operation (for example C=C+0.75).

A step 3050 makes it possible to check whether the temperature T_{LED} exceeds 40° C. (for example T_{LED}≧40° C.). This condition represents the worst case, where the counter is incremented with the maximum ageing value. For example, in the embodiment considered here, the counter 210 is incremented in a step 3052 by a value corresponding to one day's actual operation (for example C=C+1).

The result of the phase 3000 is therefore to update the ageing value of the LED module and the process returns to the phase 2000 to update the reference value I_{ref}.

After a given period, the value C of the counter 210 may exceed the threshold predefined in condition 2002, making it necessary to correct the reference value I_{ref}. This correction is realized in a step 2004, where the reference value I_{ref} is incremented.

For example, in the embodiment considered here, the reference value is incremented by a predefined percentage and the method returns to step 1002 to reset the ageing counter (for example C=0).

The method illustrated in FIG. 2 may result in the following:

the reference value I_{ref} being incremented if the LED module is used at the maximum temperature permitted (for example above 40° C.) for an entire year;

the reference value I_{ref} remains unchanged if the module is only used in the best conditions (for example below −20° C.).

The other conditions 3020, 3030 and 3040 represent intermediate cases between these two extreme cases, where the degradation of the efficiency of the LED module is less than in the worst case.

One method of use provides for the control module 200 being replaced along with the LED module.

In another method of use, only the LED module is replaced instead (and possibly the temperature sensor S). In this case, the control module 200 is restored (manually or automatically) to enable a new control cycle to be started for the new LED module.

The embodiments considered here have numerous advantages, such as:

the method may be implemented for example using a microprocessor, often already available in modern street lighting devices: the method is therefore suitable for use with portions of software code implemented by the control system of the LED module driver;

the method may be applied to any type of LED module (and nominally to any light source having similar ageing behavior), where applicable empirically determining the degradation of the source and imposing parameters accordingly;

the solution is low cost because no optical feedback is required; and

the compensation is only effected on the basis of the degradation of the source, without the influence of any external factors, such as ambient light.

In various embodiments, the inventors have noted that, despite the noteworthy results achieved with the solution discussed previously, this solution is rather costly and complex to implement. Furthermore, the measurement of the intensity of the light emitted by the module may be altered by other light sources in the same area.

Various embodiments overcome these drawbacks.

According to various embodiments, a method is provided having the features set out in the claims below. Various embodiments also concern a corresponding device, as well as a computer program product, loadable into the memory of at least one processor and including portions of software code capable of implementing the phases of the method when the product is run on at least one processor. As used here, reference to such a computer program product is understood to be equivalent to reference to a support readable by a processor containing instructions for controlling the processing system to coordinate the implementation of the method according to various embodiments. Reference to “at least one processor” is clearly intended to highlight the possibility of this invention being implemented in a modular and/or distributed manner

The claims are an integral part of the technical explanation provided herein in relation to various embodiments.

In one embodiment, the power supply signal of the LED module is controlled as a function of the temperature of the source itself and not on the basis of optical feedback. With regard to this, the inventors have noted that the intensity of the light actually emitted depends not only on usage time, but also (and primarily) on the operating temperature of the light source.

In one embodiment, there is at least one temperature sensor placed near to the LED module such as to measure an indicative value for the temperature of the LED module.

In one embodiment, the power supply signal of the LED module is varied selectively as a function of the temperature of the LED module. In one embodiment, the power supply current of the LED module is controlled.

In one embodiment, an ageing counter is used to track the ageing of the LED module. In this case, the power supply current of the LED module can be determined as a function of the value of the ageing counter.

In one embodiment, the ageing counter is incremented (or decremented) as a function of the operating temperature of the LED module.

In one embodiment, to determine the power supply current of the LED module on the basis of the value of the ageing counter a mathematical equation or a look-up table (LUT) is used.

In one embodiment, at least one “best” operating condition (at a low operating temperature) and one “worst” operating condition (at a high operating temperature) are determined. The ageing counter is subsequently incremented with an ageing value that depends on the condition chosen.

In one embodiment, the ageing value is greater for the worst condition, while the value is lesser for the best condition.

In one embodiment, the power supply current of the LED module is incremented if the ageing counter reaches (or exceeds or falls below) a predetermined threshold.

Potential and advantageous fields of application of the solution described herein are street lighting, workplace lighting and general lighting (known as lamps).

Naturally, notwithstanding the invention principle, the details and embodiments may vary significantly from the descriptions given here purely by way of example, without thereby moving outside the scope of the invention, as defined in the attached claims.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of compensating the degradation of the luminous intensity due to aging in a light source by controlling a power supply signal of said light source, the method comprising:
detecting the temperature of said light source;
determining a parameter representative of the aging of said light source as a function of said temperature; and
varying said power supply signal as a function of said parameter representative of the aging of the light source.

2. The method of claim 1, further comprising:
determining said parameter representative of the aging as a counting value of a counter; and
updating said counting value in a differentiated way as a function of said temperature.

3. The method of claim 2, further comprising:
defining a plurality of possible update values for said counting value; and
updating said counting value with an update value chosen among said plurality of possible update values as a function of said temperature.

4. The method of claim 2, further comprising:
updating said counting value with a value, which increases with increasing temperature.

5. The method of claim 2, further comprising:
varying said power supply signal when said counter reaches a predetermined counting threshold; and
reset said counter.

6. The method of claim 1, further comprising:
defining a plurality of possible operating conditions for different temperatures of said light source;
identifying among said plurality of possible operating conditions for different temperatures a respective operating condition as a function of said detected temperatures of said light source; and
varying said power supply signal as a function of said identified operating condition.

7. The method of claim 6, further comprising:
defining a pair of possible operating conditions, said pair including a operating condition for low temperatures and a operating condition for high temperatures.

8. The method of claim 1, further comprising:
varying said power supply signal with a predefined percentage.

9. The method of claim 1, further comprising:
detecting said temperature of said light source as an average value of said temperature during a time interval.

10. The method of claim 1,
wherein said varying said power supply signal as a function of said parameter includes at least one of:
varying as a function of said parameter the intensity of a power supply current of said light source;
varying as a function of said parameter the intensity of a power supply voltage of said light source; and
varying as a function of said parameter the pulse width of a pulsed power supply signal of said light source.

11. The method of claim 1,
wherein said light source is a LED light source.

12. A lighting device, comprising:
at least one light source powered by a power supply signal; and
a control module being configured for compensating the degradation of the luminous intensity due to aging in said light source by controlling said power supply signal in accordance with a method of compensating the degradation of the luminous intensity due to aging in a light source by controlling a power supply signal of said light source, the method comprising:
detecting the temperature of said light source;
determining a parameter representative of the aging of said light source as a function of said temperature; and
varying said power supply signal as a function of said parameter representative of the aging of the light source.

13. The lighting device of claim 12, further comprising:
at least one pair of light sources each being powered by a respective power supply signal; and
at least one control module being configured for controlling said power supply signal with a method of compensating the degradation of the luminous intensity due to aging in a light source by controlling a power supply signal of said light source, the method comprising:
detecting the temperature of said light source;
determining a parameter representative of the aging of said light source as a function of said temperature; and
varying said power supply signal as a function of said parameter representative of the aging of the light source,
in order to maintain the luminous intensity of said at least one pair of light sources uniform.

14. A computer program product loadable into the memory of a computer and including software code portions adapted for performing a method of compensating the degradation of the luminous intensity due to aging in a light source by controlling a power supply signal of said light source when the product is run on a computer, the method comprising:
detecting the temperature of said light source;
determining a parameter representative of the aging of said light source as a function of said temperature; and
varying said power supply signal as a function of said parameter representative of the aging of the light source.
